(19) United States
(12) Patent Application Publication
(10) Pub. No.: US 2007/0084061 A1
(43) Pub. Date: Apr. 19, 2007

(54) Mechanism for attaching trimmer line strips to a head of a trimming apparatus

(76) Inventor: James A. Bennett, Columbia, SC (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/254,054

(22) Filed: Oct. 13, 2005

(51) Int. Cl. B26B 7/00

(52) U.S. Cl. 30/276

(57) ABSTRACT

A trimmer head includes a housing encasing one or more impinging gear mechanisms. Each impinging gear mechanism includes at least one guide chamber disposed in the housing of trimmer head, and a pair of gripping gears located on opposed sides of an opening through which the trimmer line strip is received. The gripping gears engage the trimmer line strip upon insertion of the strip into the housing. At least one of the pair of gripping gears is located within the guide chamber and is movable linearly with respect to guide chamber, to permit securing of the trimmer line strip between the pair of gripping gears.

### TECHNICAL FIELD

This invention relates generally to a weed trimming apparatus and, more particularly, to a head of the weed trimming apparatus. The head of the trimming apparatus should be of the type capable of accepting flexible trimmer line strips as the cutting elements. Specifically, the present invention relates to an impinging gear mechanism adapted for securing at least one trimmer line strip within the head of the trimming apparatus.

### BACKGROUND OF THE INVENTION

Grass, brush and weed trimming devices, utilizing a cutting element in the form of segments or strips of plastic string trimmer line, have become popular for trimming lawns and other landscapes. Most of these trimming devices, often referred to as trimmers, are electric or gas-powered, hand-held devices employing a rotatable trimmer head mounted onto a carrying handle so that the user can utilize the trimmer in a standing position. In older versions, the cutting element in these types of trimming devices was typically in the form of several feet of nylon or other plastic monofilament line wound on a storage reel within and carried by the rotating trimmer head. A few inches of the monofilament line would extend radially outward from the head at one or two points through eyelets or openings in the trimmer head and spin around the rotating trimmer head when in operation.

Rotation of the head at relatively high speeds (2,000 to 20,000 RPM for example) caused the line to strike and cut the grass, brush and weeds in the path of the spinning line. Cutting of grass, brush and weeds eventually causes the monofilament line to become worn and abraded, and oftentimes, to break. In these older units, upon depletion or breakage of the line from cutting during operation of the trimmer, the line could be extended and replenished from the wound spool within the trimmer head until the line within the spool was consumed. Then, new monofilament line would have to be rewound onto the storage spool and fitted through the eyelets before further trimming could take place.

More recently, trimmers have been developed that require shorter, fixed lengths of flexible plastic monofilament trimmer line called “strips.” Typically, these strips of monofilament line are made of nylon or other hard plastic just like the longer length spool-wound monofilament line. However, these strips are only about 4 to about 24 inches long, depending upon the size and type of trimming device employed. For example, some strips of monofilament trimmer line are adapted to extend through more than one eyelet or opening within the head of the trimming apparatus and, therefore, must be long enough to extend across the entire head of the trimmer with sufficient excess line protruding from the head to be used as the cutting elements extending from each eyelet. On the other hand, some strips are adapted to be used by extending through only one eyelet or opening and, therefore, need only be long enough to extend radially outward from the center of the head in a length sufficient to be used as the cutting element extending from that eyelet.

Trimmer line strips can also have a wide range of cross sectional diameters depending upon their intended use, but each strip is typically slightly larger in diameter than previous wound string trimmer lines, providing for a longer wear life. Smaller diameter monofilament strips are often used for intermittent home lawn use and are typically from about 0.05 inches to about 0.1 inches in diameter. Commercial and industrial trimmers typically use larger diameter monofilaments, typically on the order of from about 0.1 inches to about 0.155 inches or greater.

Notwithstanding the diameter of the monofilament, all plastic monofilament lines, whether short strips or long wound lengths, eventually wear out or break with use. When a monofilament trimmer line strip breaks or wears to a point near the eyelet within the housing of the rotating head through which it is positioned, it must be entirely replaced individually, unlike the wound spools of monofilament line that can just be extended such as by a “bump and feed” mechanism.

When a trimmer line strip breaks or is used up, it must be replaced, or “re-strung.” If a user is out in the field, he will either have to return to the place where replacement strips are stored to obtain a new one, or carry one or more replacements with him. If the user is carrying replacement strips, replacement of one or more strips may take place in the field where there are little, if any, tools. A trimmer head that requires tools and disassembly of any portion of the head in order to change the trimmer line strip delays operation and, oftentimes, prevents the user from changing the strip or strips in the field. Thus, the need exists for a mechanism within the trimmer head that will enable the user to replace one or more trimmer strips quickly, safely and easily, and without the need for tools or disassembly of the trimmer head. Moreover, the mechanism must also be capable of holding the trimmer strips securely while the trimmer is in use.

SUMMARY OF THE INVENTION

The present invention is directed toward an impinging gear mechanism within the trimmer head of a trimming apparatus, the trimmer head being of the type that uses trimmer line strips (as opposed to spooled or wound lengths of monofilament line) as the cutting element. The impinging gear mechanism of the present invention allows the operator of the trimming apparatus to quickly and easily insert one end of a trimmer line strip through an eyelet and into an opening of the trimmer head, and effectively holds the trimmer line strip in place while in operation.

Generally, the present invention provides a trimmer head of the type capable of utilizing one or more trimmer line strips as the cutting element or elements for the trimming apparatus. More particularly, the trimmer head of the present invention is of the type adapted for introducing or inserting one trimmer line strip into each trimmer line opening within the housing of the trimmer head. That is, each trimmer line strip extends through only one eyelet or opening, not a plurality of openings. The trimmer head should also be of the type having a central axis of rotation.

The present invention may be achieved by a trimmer head comprising a housing having a guide chamber therein; an opening disposed in the housing radially of the central axis of rotation, the housing receiving a portion of a trimmer line strip through the opening; a pair of gripping gears located on opposed sides of the opening and engaging the trimmer line strip, at least one gripping gear of the pair of gripping gears located within and movable linearly with respect to the guide chamber, to permit securing of the trimmer line strip between the pair of gripping gears.

Advantageously, the present invention allows the operator of the trimming apparatus to quickly and easily insert trimmer line strips into the trimmer head, and provides an effective mechanism for holding the trimmer line strips in place while the trimming apparatus is in operation. Furthermore, the present invention may advantageously permit the trimmer head to be re-strung quickly and easily with essentially any gauge (i.e., diameter) trimmer line strips known in the art.

It is envisioned that the present invention be used in conjunction with a weed trimming apparatus of the type having a rotatable trimmer head for receiving one or more lengths of replaceable trimmer line strips, the trimmer line strips being releasably engagable by one-way gripping means of simple design and construction that is economical to manufacture, long-lasting, and adaptable to a wide variety of trimmer head designs.

One or more of the foregoing advantages of the present invention over the known art relating to vegetation trimmers, may become apparent from the specification and drawings that follows.

### BRIEF DESCRIPTION OF THE DRAWINGS

For a complete understanding of one or more embodiments and the structural features of the present invention, reference should be made to the following detailed description and accompanying drawings wherein

FIG. 1 is a side elevational view of the trimmer head of the present invention;

FIG. 2 is an exploded view of the trimmer head of the present invention;

FIG. 3 is an elevational view of a base portion of the trimmer head of the present invention, with a cover portion of the housing removed, depicting a movable gripping gear and guide wheel in the disengaged position, allowing insertion of a trimmer line strip;

FIG. 4 is an elevational view of the base portion of the trimmer head of the present invention, with the cover portion removed, as shown in FIG. 3, but depicting the guide wheel partially cut away and the movable gripping gear in the engaged position, preventing removal of the trimmer line strip; and

FIG. 5 is a partial, elevational view schematically depicting a further embodiment of an impinging gear mechanism of the present invention engaging a trimmer line strip.

FIG. 6 is a cross-sectional view taken along line 6-6 in FIG. 4.

### DETAILED DESCRIPTION OF ILLUSTRATIVE EMBODIMENTS

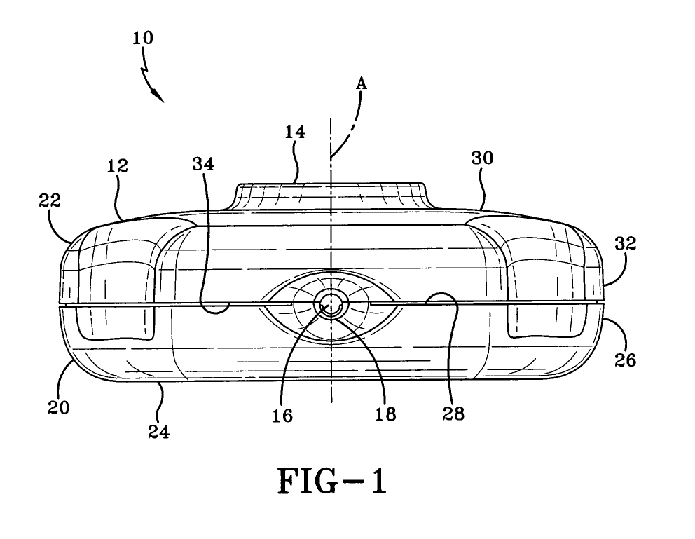

One representation of a trimmer head embodying the concepts of the present invention is generally designated by the numeral 10 in FIG. 1. It will be appreciated that the trimmer head of the present invention may take any form known in the art and should not be limited by the particular drawings and descriptions set forth herein, the present invention being defined by the scope of the claims and its equivalent structures and means falling within the scope of those claims as recited herein. To be operatively effective in cutting weeds and grasses, trimmer head 10 should be of the type capable of utilizing at least one trimmer line strip S as a cutting element. Such trimmer head may also be capable of performing other functions using other elements such as blades or brushes in replacement of the trimmer line strip S; however, the present invention is more particularly directed to the use of the trimmer head 10 with the trimmer line strip S.

The trimmer head 10 of the present invention includes a housing 12 defining the body or outer shell of the trimmer head 10. Housing 12 may take any functionally effective shape known in the art and is shown generally in the drawings for this embodiment as being disc-shaped. Housing 12 can be made from any material known in the art, such as, for example, hard, rigid, wear-resistant plastics.

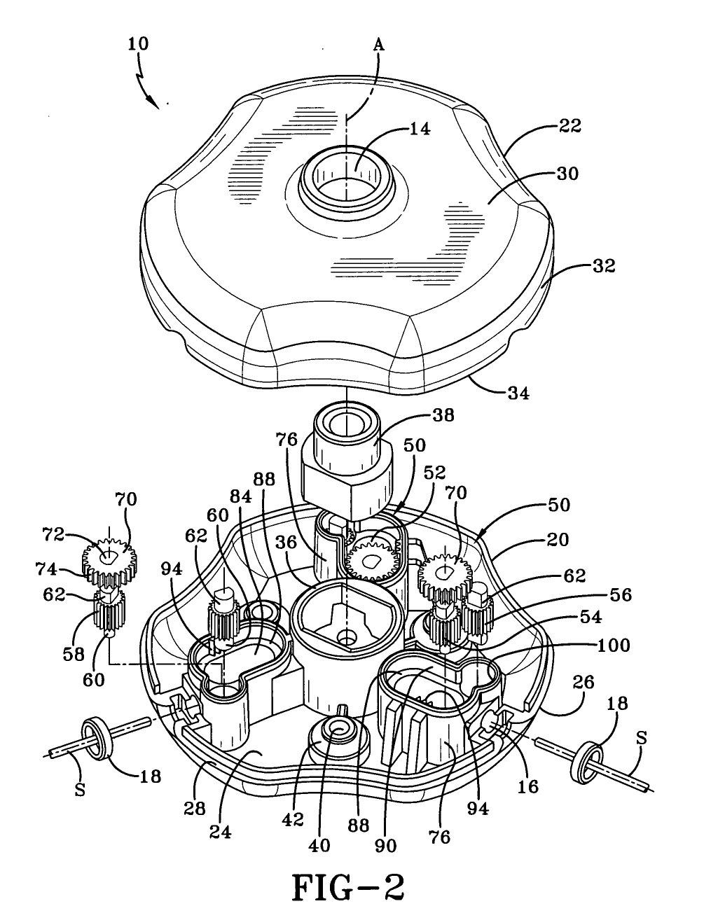

As shown in FIGS. 1 and 2, housing 12 includes a central opening 14 for receiving a carrier handle and/or drive shaft (not shown) for effectively operating the trimmer head 10. The drive shaft is used to operatively rotate the trimmer head 10 about a central axis of rotation A that permits the trimmer line strips S employed in the trimmer head 10 to effectively cut weeds or grasses. At least one other opening 16 may be disposed radially of the central axis of rotation A in the housing 12, each such opening 16 being adapted for receiving at least a portion of a trimmer line strip S therethrough. That is, trimmer head 10 of the present invention should preferably be of the type capable of permitting the user to insert and secure a portion of a trimmer line strip S through an opening 16 from outside of the housing 12 without requiring access to the interior of the housing 12.

More particularly, the trimmer head 10 may include an eyelet 18 defining the entrance of each opening 16 in the housing 12. Each eyelet 18 provides a smooth surface for receiving the trimmer line strip S through the opening 16, thereby reducing wear on both the trimmer line strip S and on the trimmer head housing 12 during operation. In a preferred embodiment, each eyelet 18 may be recessed within the housing 12 to provide further rigidity and strength to the housing 12 and to prevent excessive wear of the trimmer line strips S while in use.

With particular reference to the illustrated embodiment shown in FIGS. 1 and 2, housing 12 may include a base portion 20 and a cover portion 22 operatively attached to the base portion 20. Cover portion 22 may be permanently or releasably connected to the base portion 20 by any means known in the art, such as, by adhesives, welds, fasteners, snaps, latches, screws, and the like. In FIGS. 2, 3 and 4, openings can be seen in the base portion 20 to releasably connect the base portion 20 to the cover portion 22. Base portion 20 is shown as having a generally flat surface 24 and a base sidewall 26 extending axially with respect to the central axis of rotation A around the periphery of the flat surface 24 toward the cover portion 22. A portion of each eyelet 18 and each opening 16 may be disposed in the edge 28 of the base sidewall 26.

Similarly, cover portion 22 is shown as having a generally flat surface 30 and a cover sidewall 32 extending axially with respect to the central axis of rotation A around the periphery of the flat surface 30 toward the base portion 20, such that base sidewall 28 and cover sidewall 32 are adapted to mate with each other in forming the housing 12. Like the base portion 20, a portion of each eyelet 18 and each opening 16 may be disposed in the edge 34 of the cover sidewall 32, such that together, the mating sidewalls 26, 32 of base portion 20 and cover portion 22 together define one or more openings 16 providing access to the interior of the housing 12.

In embodiments where more than one opening 16 is provided in the housing 12, the openings 16 should be equally spaced within mating sidewalls 26, 32 of base portion 20 and cover portion 22 and radially aligned with respect to the central axis of rotation A. If two openings are employed, the openings are preferably aligned on opposing sides of the trimmer head 10. If three or more openings 16 are employed, the openings are preferably aligned in equally spaced relationship to each other. Equally spaced openings may help to maintain the balance of the trimmer head 10 during rotational use.

With further reference to the illustrated embodiment of FIG. 2, it can be seen that base portion 20, and more generally, housing 12, may be formed with a central hub 36, which extends inwardly of the housing 12 from the center of the base portion 20 in axial alignment with the central axis of rotation A and may be adapted to receive an attachment, such as connection piece 38 also in axial alignment with the central axis of rotation A, to enable the user to connect a carrier handle and/or a drive shaft (not shown) of a conventional internal combustion or electric powered trimmer apparatus to the trimmer head 10. Connection piece 38 is shown as capable of extending through central opening 14 in the cover portion 22 of housing 12, and may be a separate piece from or integrally a part of the carrier handle/drive shaft.

As noted above, one or more openings, such as screw holes 40, may be disposed in the base portion 20 for receiving essentially any means known in the art, e.g., screws (not shown), for attaching the base portion 20 to the cover portion 22. Where screws or structurally similar fasteners are used, the cover portion may include receiving apertures aligned with the screw holes 40 for receiving a pointed end of the screw. In the embodiment shown in FIG. 2, the apertures are not received completely through the flat surface 30 of the cover portion 22 and, therefore, cannot be seen in the drawing figure. Each screw hole 40 may be defined generally by an alignment support 42. The support 42 may be either recessed within base portion 20 of housing 12, or extend inwardly of the housing to provide strength and support to the housing 12 through which the screw will extend. By recessing the screw, it will be appreciated that the base portion 20 of trimmer head 10 will maintain a relatively smooth and flat surface 24 that may be beneficial during operation of the trimmer head 10.

Also noted above, the entrance to one or more openings may be defined by eyelets 18 in the housing 12. The opening 16 extend into the housing 12 and receives a length of trimmer line strip S for a length In the embodiment shown in FIGS. 2, 3 and 4, three equally spaced and separate openings are formed by eyelets 18 through which a length of trimmer line, such as strip S, extends. That is, each eyelet 18 forming an entrance to opening 16 should have a width capable of accommodating any commonly used thickness of trimmer line strip S, or at least a specified diameter of the trimmer line strip. Generally, trimmer line strips, such as strip S, is of a finite length of about 4 to about 20 inches. Trimmer line strips S may be formed from any conventional trimmer line material, including flexible monofilament plastic, such as nylon. Commonly used trimmer line thicknesses range from about 0.05 to about 0.15 inches, or greater, in diameter, and may have any cross-sectional configuration known in the art.

It will be appreciated that eyelet 18 does not necessarily have to be used in conjunction with opening 16, the entrance of opening 16 then being defined by the housing 12 itself. However, as noted above, disposing each eyelet 18 within an opening 16 recessed in the sidewall of housing 12 may aid in providing support, rigidity and strength to the housing 12, and may reduce wear of the trimmer line strips S during operation.

Many, if not all, of the other elements within housing 12 are directed toward releasably connecting and securing one or more trimmer line strips S within the housing using one or more impinging gear mechanisms designated generally by the numeral 50 in the drawings. In the embodiment shown in FIGS. 2-4, for example, three equally-spaced and separate impinging gear mechanisms 50 are shown. It will be appreciated that each impinging gear mechanism 50 functions separate and apart from each and every other impinging gear mechanism, and therefore, the trimmer head 10 of the embodiment shown can accommodate up to three separate trimmer line strips S, one being inserted into each impinging gear mechanism 50 as explained below. The discussion of the impinging gear mechanism that follows focuses substantially on only one such mechanism, it being understood that each of the other impinging gear mechanisms have the same elements and function independently in substantially the same way.

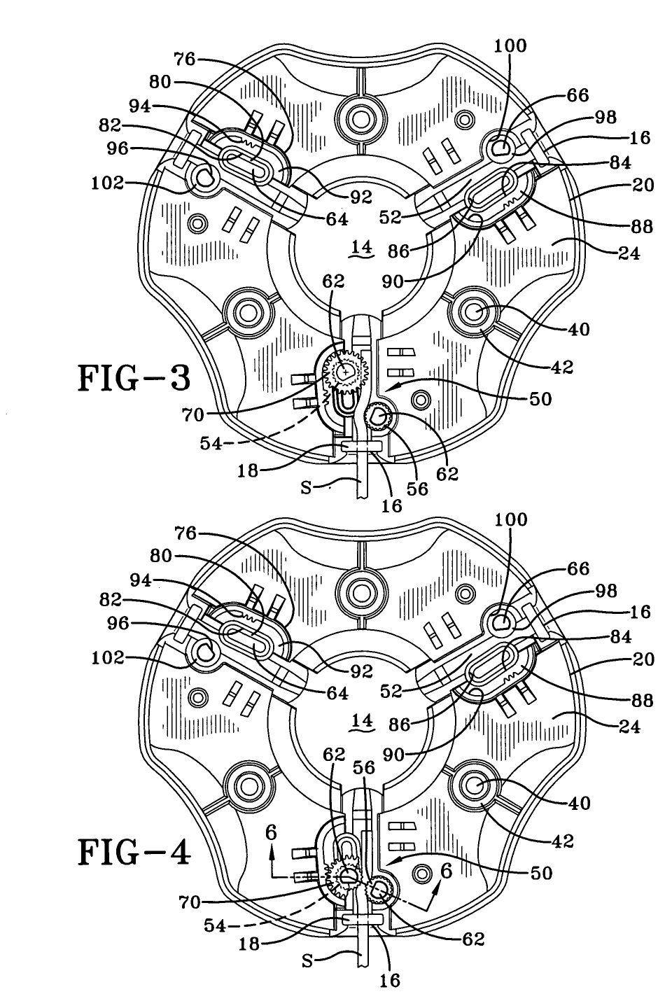

Each impinging gear mechanism 50 includes at least one guide chamber 52 disposed in the housing 12 of trimmer head 10, and a pair of gripping gears 54, 56 located on opposed sides of opening 16 through which the trimmer line strip S is received. Gripping gears 54, 56 engage the trimmer line strip S upon insertion of the strip S into the housing and though the opening 16. At least one of the pair of gripping gears, such as gear 54, is located within guide chamber 52 and is movable linearly with respect to guide chamber 52. Thus, as shown in FIG. 3, it will be appreciated that, upon insertion of trimmer line strip S through eyelet 18 and into opening 16, the strip S will make contact with the pair of gripping gears 54, 56 and, upon further insertion into the opening, will move at least one of the gears 54 through guide chamber 52 and away from the other gear 56 so as to permit the complete insertion of a predetermined length of the trimmer line strip S into the housing 12. As will become more readily apparent below and as shown in FIG. 4, once the predetermined length of trimmer line strip S is fully inserted, the at least one of the pair of gripping gears 54 that initially moved away from the other 56 of the pair of gripping gears, will operatively move back toward the other 56 to operatively secure the trimmer line strip S by impinging the strip between the pair of gears 54, 56.

In the embodiments shown, gripping gears 54, 56 include wheel-like or cylindrical structures having a plurality of small teeth 58 extending from the periphery of the structure. However, it will be understood that essentially any structure or pair of structures adapted to move linearly with respect to the guide chamber and capable of securing the trimmer line strip S between the structure and a like or similarly configured structure, by impinging the strip S between the structures within one or more guide chambers, will suffice as gripping gears.

In the embodiments shown, each gripping gear 54, 56 includes posts 60, 62 at each end. Post 60 may take any shape known in the art and may be used to maintain the gear within a channel 64, 66 defined as part of the guide chamber 52. Where the gear is to be moveable linearly, the post 60 may be round in shape in order to slide or rotate smoothly in the channel 64 defined as part of the guide chamber 52. Where the gear is to be fixed or stationary, such as is shown in FIGS. 2, 3 and 4 for gear 56, the post 60 may have a different shape in order to provide a means for preventing the rotation of the gear. For example, in the embodiment shown, post 60 on gear 56 is D-shaped. This shape may be complementary to the shape of the channel or aperture 66, as shown in FIGS. 3 and 4, so as to maintain the gear in a fixed position.

Likewise, post 62 may also take any shape known in the art suitable for the purposes set forth herein. Post 62 may be used to position a fixed gear, such as gear 56, into a complementary-shaped channel (not shown) in the cover portion of the housing, or may attach the movable gear, such as gear 54, to a guide wheel 70. As shown, the post 62 for the fixed gear 56 is D-shaped, and the post for the moveable gear 54 is also D-shaped.

Guide wheel 70 may be mounted to the movable gripping gear 54 by any means or method known in the art and may be movable linearly within the guide chamber 52 as described below. In the embodiments shown, guide wheel 70 includes a central receiving hole 72 having a shape complementary to the shape of the post 62 on the movable gripping gear 54, such that the post 62 is connected to the guide wheel 70 when received in the receiving hole 72. Upon joining the gripping gear 54 and the guide wheel 70, movement, whether linear or rotational, of either the gripping gear 54 or the guide wheel 70 will result in the movement of the other of the two.

Like gripping gears 54, 56, guide wheel 70 is shown as having a wheel-like or cylindrical structure with a plurality of small teeth 74 extending from the periphery of the structure. It will be understood, however, that essentially any structure suitable for performing the functions of the guide wheel and adapted to move linearly with respect to the guide chamber will be sufficient for use as a guide wheel 70, the structure shown in the drawings being one such suitable embodiment for the present invention.

Turning to the guide chamber 52, it will be understood that each guide chamber 52 may include one or both of the pair of gripping gears 54, 56. Where a guide chamber 52 includes only one of the pair of gripping gears, each impinging gear mechanism 50 may include a second guide chamber that includes the other of the pair of gripping gears.

Generally, a guide wall 76 forms and defines each guide chamber 52. Each guide wall 76 acts as a support and/or a guide for the moveable and/or stationary gripping gears 54, 56 and/or the guide wheel 70, and further includes one or more channel walls that further define various channels located within the guide chamber 52.

In the embodiment shown in FIGS. 2-4 and 6, guide wall 76 includes a first channel wall 80 that defines the elongated channel 64 through which post 60 of movable gear 54 linearly moves. The channel wall 80 may have a smooth surface 82 at the top thereof upon which the movable gear 54 may rest and be supported to the extent necessary. That is, movable gripping gear 54 may be carried by the first channel wall 80 on its top surface 82. A second channel wall 84 defines a larger, but similarly configured, elongated channel 86 through which the movable gripping gear 54 linearly moves. This channel wall 84 may have a smooth surface 88 at the top thereof upon which the guide wheel 70 may rest and be supported to the extent necessary. Thus, guide wheel 70 may be carried by the second channel wall 84 on its top surface 88. A third channel wall 90 then defines an even larger channel 92 through which the movable guide wheel 70 linearly moves. The top of the second channel wall 84 and side of the third channel wall 90 may be disposed in a manner with respect to each other, as shown in FIG. 2, to create a so-called guide track for the guide wheel 70. Hence, guide wheel 70 may be directed in a linearly back and forth motion along the guide track to enable the movable gripping gear 54 to simultaneously and likewise move back and forth in a linear direction through its elongated channel 80.

The side of the third channel wall 90 of guide wall 76 may include a plurality of small teeth 94 disposed inwardly along the guide track. The teeth 94 may be adapted to mesh with the gear teeth 74 of guide wheel 70 to help maintain the guide wheel 70 in a position at the end of the elongated channel 92 during operational of the trimmer head 10. In doing so, it will be appreciated that gripping gear 54 will thereby be moved and maintained against the trimmer line strip S as shown in FIG. 4 and, together with the other gripping gear 56, will impinge the trimmer line strip S therebetween. The teeth 94 will also cause rotational movement of the guide wheel 70 and, in turn, the movable gripping gear 54 upon release.

In the embodiment shown, guide wall 76 comprises both of the gripping gears 54 and 56. Thus, guide wall 76 further includes a fourth channel wall 96 that defines the aperture or channel 66 in which post 60 of stationary gear 56 is disposed. The channel wall 96 may have a smooth surface 98 at the top thereof upon which the stationary gear 56 may rest and be supported to the extent necessary. That is, stationary gripping gear 56 may be carried by the fourth channel wall 96 on its top surface 98. A fifth channel wall 100 defines a larger, but similarly configured channel or aperture 102 compared to channel wall 96, in which the stationary or fixed gripping gear 56 is disposed. It will be understood that a sixth channel wall (not shown) would define a smaller, essentially identical channel (not shown) to that of its counterpart channel 66, in which post 62 of stationary gear 56 would be disposed, thereby maintaining gripping gear 56 is a stationary, fixed position.

Where guide chamber 52 includes both of the gripping gears 54, 56, the guide wall 76 may substantially surround the pair of gripping gears 54 and 56 in an operative manner. More particularly, the guide wall 76 may project inwardly from the flat surface 24 of the base portion 20 of housing 12 substantially parallel with the axis of rotation A, all the way to the flat surface of the cover portion 22, thereby encasing the gripping gears 54, 56, and optionally, the guide wheel 70 therein.

Thus, in operation, it will be appreciated that one end of trimmer line strip S may be guided through one of the openings 16 disposed radially of the center axis of rotation A and forced between the gripping wheels 54, 56. The passage of trimmer line strip S between gripping wheels 54, 56 causes one or both gripping wheels (i.e. those that are movable) to slide and, optionally, to rotate, depending upon the type of structure used as the gripping gears and or guide wheel, away from the other of the pair of gripping gears. As shown in the drawings, gripping gear 54 would rotate in a counter-clockwise direction.

Upon completion of the act of inserting the trimmer line strip S into the trimmer head 10, trimmer line strip S cannot be easily pulled out of trimmer head 10, because any forces acting on trimmer line strip S in a radially outward direction will also act on gripping gear 54 and, optionally, 56, as well as guide wheel 70, thereby causing the gripping gear 54 and guide wheel 70 to rotate (if possible, and clockwise as shown in the drawings) and slide radially outward. Such radially outward forces causes gripping gear 54 to move toward gripping gear 56, thereby creating a clamping or impinging force capable of holding and securing trimmer line strip S in place within opening 16. In addition, once trimmer line strip S is forced into trimmer head 10, the teeth 58 of gripping gears 54, 56 engage trimmer line strip S, becoming embedded in trimmer line strip S to further secure the trimmer line strip S. That is, with trimmer head 10 rotating in either direction, the clamping or impinging force is enhanced due to centrifugal force created by the rotation of trimmer head 10 acting on the centers of gravity of the gripping gears, which in turn, causes the gears to move closer together, clamping or impinging the strip S between them, and causes the teeth 58 to embed even more deeply in the trimmer line strip S.

The clamping or impinging force is further enhanced by the centrifugal force acting on guide wheel 70. Rotation of trimmer head 10 causes guide wheel 70 to slide radially outward away from the center axis of rotation A. The teeth 94 in the guide wall 76, and specifically, with respect to the embodiment shown in FIGS. 2-4, in the third channel wall 90, engage the gear teeth 74 of guide wheel 70 and provide a locking type of mechanism on the guide wheel 70 to prevent the guide wheel 70 from sliding back toward the center axis of rotation A and may further prevent rotation of guide wheel 70 during rotational operation of the trimmer head. This, in turn, prevents any possible sliding of the movable gripping gear 54 or any further rotation of the movable gripping gear 54, causing the gear teeth 58 of gripping gears 54, 56 to be maintained and deeply embedded in the trimmer line strip S.

Moreover, it will be appreciated that if one of the trimmer line strips S fails during use, an operator of trimmer head 10 merely has to remove the old trimmer line strip S by slowly pushing the strip S back into the trimmer head to release the impinging forces on the strip S and slowly removing the same, and then insert a new trimmer line strip S into that opening 16 in the trimmer head 10. The subject invention does not require disassembly of trimmer head 10 to accomplish re-threading of the trimmer line strips S. Periodically, trimmer head 10 may be opened by removing the screws, or other means of fastening the base portion and cover portion of the housing together, to dispose of any fragments of broken trimmer line strips or other debris.

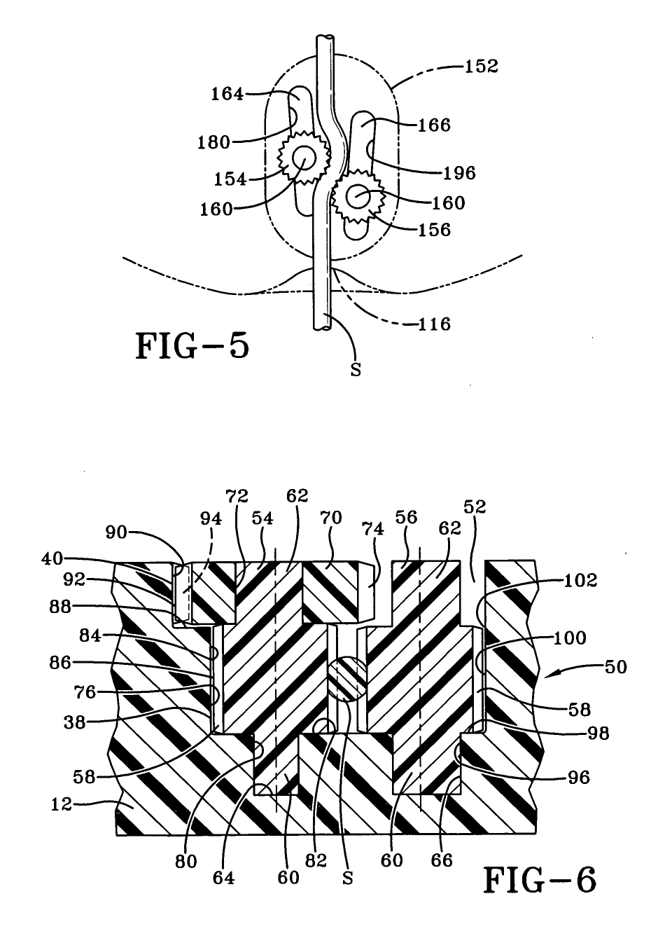

In an alternative embodiment as shown in FIG. 5, both gripping gears 154 and 156 are movable linearly and include elongated guide walls (not shown) and channel walls, including at least walls 180, 196, defining elongated channels 164, 166 for posts 160 of gripping gears 154 and 156. Thus, upon inserting a trimmer line strip S into an opening like opening 116, gripping gears 154, 156 engage the trimmer line strip S, and both of the pair of gripping gears 154, 156 move linearly through their respective channels, along with their respective posts 160 through channels 164, 166, with respect to guide chamber, shown as 152 in phantom, to allow complete insertion of a predetermined length of the trimmer line strip S. Once completely inserted into the housing 12, the trimmer line strip S will be secured within the housing 12 when the pair of gripping gears 154, 156, which initially moved apart to allow the insertion of the strip S, operatively move back toward each other to operatively secure the trimmer line strip S by impinging the strip between the pair of gears 154, 156 in a manner like that previously described for the movable and stationary pair of gripping gears.

Thus, it should be evident that the trimmer head of the present invention is effective in allowing the operator to replace trimmer line strips in the field quickly and easily. In addition, the trimmer head holds one or more trimmer strings securely while the trimmer is in use. Although the present invention has been described hereinabove with reference to particular means, materials, structures and embodiments, it will be understood to persons having ordinary skill in the art that various changes and modifications can be made to the invention that will fall within the scope of the appended claims without affecting the essential nature of the invention. The invention is, therefore, not limited to the particulars disclosed, but rather extends to all equivalents within the scope of the claims.

What is claimed is:

1. A trimmer head capable of utilizing at least one trimmer line strip as a cutting element, the trimmer head having a central axis of rotation and comprising:
a housing having a guide chamber therein;
an opening disposed in said housing radially of the central axis of rotation, said housing receiving a portion of a trimmer line strip through said opening;
a pair of gripping gears located on opposed sides of said opening and engaging the trimmer line strip, at least one gripping gear of the pair of gripping gears located within and movable linearly with respect to said guide chamber, to permit securing of the trimmer line strip between the pair of gripping gears.

2. The trimmer head according to claim 1, further comprising a guide wheel mounted to said movable gripping gear and being movable linearly within said guide chamber.

3. The trimmer head according to claim 2, wherein said guide chamber includes a guide track disposed therein, said guide wheel being carried by said guide track.

4. The trimmer head according to claim 1, wherein a guide wall substantially surrounds the pair of gripping gears and projects inwardly from said housing parallel to the central axis of rotation to define said guide chamber.

5. The trimmer head according to claim 1, wherein a both gears of said pair of gripping gears are located within said guide chamber.

6. The trimmer head according to claim 1, wherein one of said gears of said pair of gripping gears is affixed within said guide chamber.

7. The trimmer head according to claim 1, wherein both gears of said pair of gripping gears are movable linearly within said guide chamber.

8. The trimmer head according to claim 1, wherein said housing includes a base portion; and a cover portion permanently or releasably secured to the base portion.

9. The trimmer head according to claim 1, further comprising an eyelet defining an entrance of said opening disposed in said housing.

10. The trimmer head according to claim 1, further comprising a second opening disposed in said housing radially of the central axis of rotation, said housing receiving a portion of a second trimmer line strip through said second opening.

11. The trimmer head according to claim 10, further comprising a second guide chamber disposed with said housing and a second pair of gripping gears located on opposed sides of said second opening and engaging the second trimmer line strip, at least one gripping gear of said second pair of gripping gears located within and movable linearly with respect to said second guide chamber, to permit securing of the second trimmer line strip between the second pair of gripping gears.

12. The trimmer head according to claim 10, further comprising a second guide wheel mounted to said movable gripping gear of said second pair of gripping gears and being movable linearly within said second guide chamber.

13. The trimmer head according to claim 1, further comprising a third opening disposed in said housing radially of the central axis of rotation, said housing receiving a portion of a third trimmer line strip through said third opening.

14. The trimmer head according to claim 13, further comprising a third guide chamber disposed with said housing and a third pair of gripping gears located equal distance from both of said first and second openings and engaging the third trimmer line strip, at least one gripping gear of said third pair of gripping gears located within and movable linearly with respect to said third guide chamber, to permit securing of the third trimmer line strip between the third pair of gripping gears.

15. The trimmer head according to claim 13, further comprising a third guide wheel mounted to said movable gripping gear of said third pair of gripping gears and being movable linearly within said third guide chamber.
